(19) United States
(12) Patent Application Publication
(10) Pub. No.: US 2004/0254588 A1
(43) Pub. Date: Dec. 16, 2004

(54) Skincare apparatus

(76) Inventor: Yong Seong Kim, Seoul (KR)

Correspondence Address: ROTH & GOLDMAN, P.A., 523 W. 6TH STREET, SUITE 707, LOS ANGELES, CA, 90014, US

(21) Appl. No.: 10/838,447

(22) Filed: May 4, 2004

(30) Foreign Application Priority Data
Jun. 10, 2003 (KR) 20-2003-18216
Jul. 2, 2003 (KR) 20-2003-21230
Jul. 29, 2003 (KR) 20-2003-24521
Jul. 29, 2003 (KR) 20-2003-24522
Mar. 18, 2004 (KR) 10-2004-18589

(51) Int. Cl. B26D 7/06

(52) U.S. Cl. 606/131

(57) ABSTRACT

The present invention has an object to provide a skincare apparatus capable of engaging a filter to a hand piece and easily separating the same for thereby achieving an easier cleaning. There is provided a skincare apparatus that includes a body for generating a suction force, a suction hose of which one end is engaged with the body, and the other end is engaged with a hand piece, a hand piece adapted to receive a suction force from the suction hose and having a body held by a user's hand, and a tip engaged with the hand piece and directly contacting with skin, comprising an engaging means provided in the hand piece wherein a tip is engaged with one end of the same, and a filter provided at a portion engaged by the engaging means for thereby filtering a skin foreign substance removed from skin based on a suction force.

### BACKGROUND OF THE INVENTION

1. Field of the Invention

The present invention relates to a skincare apparatus, and in particular to a skincare apparatus capable of effectively removing a skin foreign substance such as a skin corneous tissue, etc.

2. Description of the Background Art

Generally, a skincare device such as a peeling device, etc. is used in order to remove a foreign substance such as a skin corneous tissue from a human skin. The conventional skincare device includes a body for generating suction force, and a hand piece part directly contacting with skin and receiving a suction force from the body for thereby sucking a skin foreign substance such as a skin corneous tissue, etc.

The skin foreign substances such as skin keratin, etc. removed from a hand piece are sucked into the body, and the skin foreign substances are filtered by a filter provided in the body.

Therefore, in the conventional art, a user should separate and clean a filter from the body in order to clean a skin foreign substance filtered by the filter. The inconvenience, cost and time are increased.

### SUMMARY OF THE INVENTION

Accordingly, it is an object of the present invention to provide a skincare apparatus capable of overcoming the problems encountered in the conventional art.

It is another object of the present invention to provide a skincare apparatus in which a filter is engaged to a hand piece and is easily separated for thereby achieving an easier cleaning.

To achieve the above objects, according to a first embodiment of the present invention, there is provided a skincare apparatus that includes a body for generating a suction force, a suction hose of which one end is engaged with the body, and the other end is engaged with a hand piece, a hand piece adapted to receive a suction force from the suction hose and having a body held by a user's hand, and a tip engaged with the hand piece and directly contacting with skin, comprising an engaging part provided in the hand piece wherein a tip is engaged with one end of the same, and a filter provided at a portion engaged by the engaging part for thereby filtering a foreign substance from a skin based on a suction force.

According to a second embodiment of the present invention, there is provided a skincare apparatus that includes a hand piece having two or more than two pieces are detachably engaged by an engaging part for thereby forming one body, wherein a filter is provided at a portion of the engagement for thereby filtering a skin foreign substance removed from skin based on a suction force.

According to a third embodiment of the present invention, there is provided a skincare apparatus that includes a tip formed in an integration body wherein both sides of the same are opened, and a diamond powder is electrodeposited on an end portion of one surface contacting with skin.

According to a fourth embodiment of the present invention, there is provided a skincare apparatus that includes a tip having an engaging part provided at one end of the tip for engaging with a hand piece; and

a filter provided in a portion engaged by the engaging part for filtering a skin foreign substance removed from skin based on a suction force.

According to a fifth embodiment of the present invention, there is provided a skincare apparatus that includes a hand piece formed in an integration body, is wherein both sides of the same are opened, and an inwardly bent engaging step is formed in one end of one side of the same; and a tip formed in an integration body, wherein both sides are opened, and an outwardly bent engaging step is formed at both side ends, and one side of the same is positioned in an inner side of the hand piece, so that it is prevented from being escaped from the outside of the hand piece by the engaging step, wherein the body of the tip has a certain clearance formed in such a manner that a width of the same is smaller than the opened portions of the end portions of the hand piece.

### BRIEF DESCRIPTION OF THE DRAWINGS

The preferred embodiments of the present invention will be described with reference to the accompanying drawings.

FIG. 1 is a view illustrating an outlook of a skincare apparatus according to the present invention;

FIGS. 2 through 15 are views illustrating a hand piece and a tip adapted to remove a skin foreign substance according to various embodiments of the present invention;

FIG. 16 is a view illustrating a circuit block provided in the interior of a body according to an embodiment of the present invention; and

FIGS. 17 and 18 are views illustrating the construction of another embodiment of the present invention.

### DETAILED DESCRIPTION OF THE PREFERRED EMBODIMENTS

The embodiments of the present invention will be described with reference to the accompanying drawings.

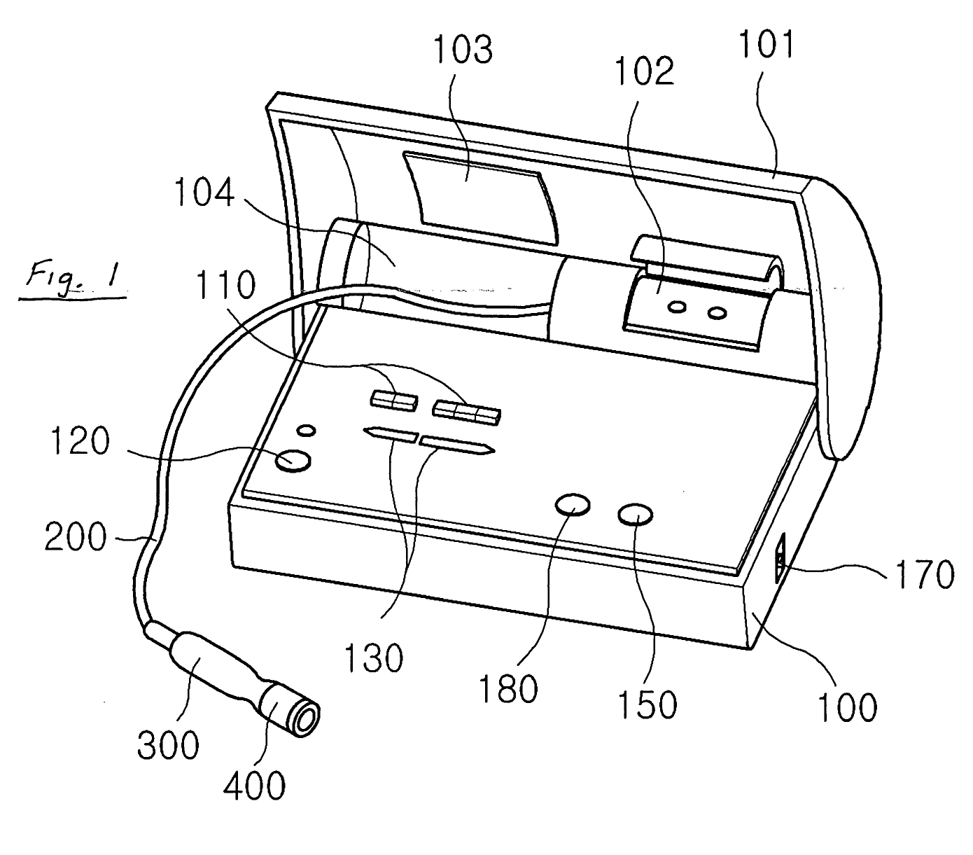

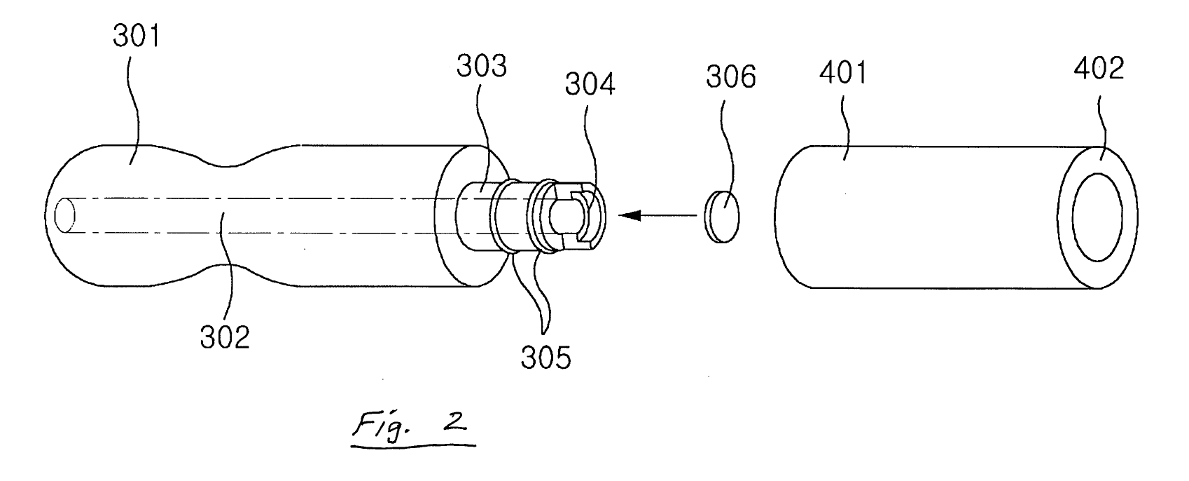

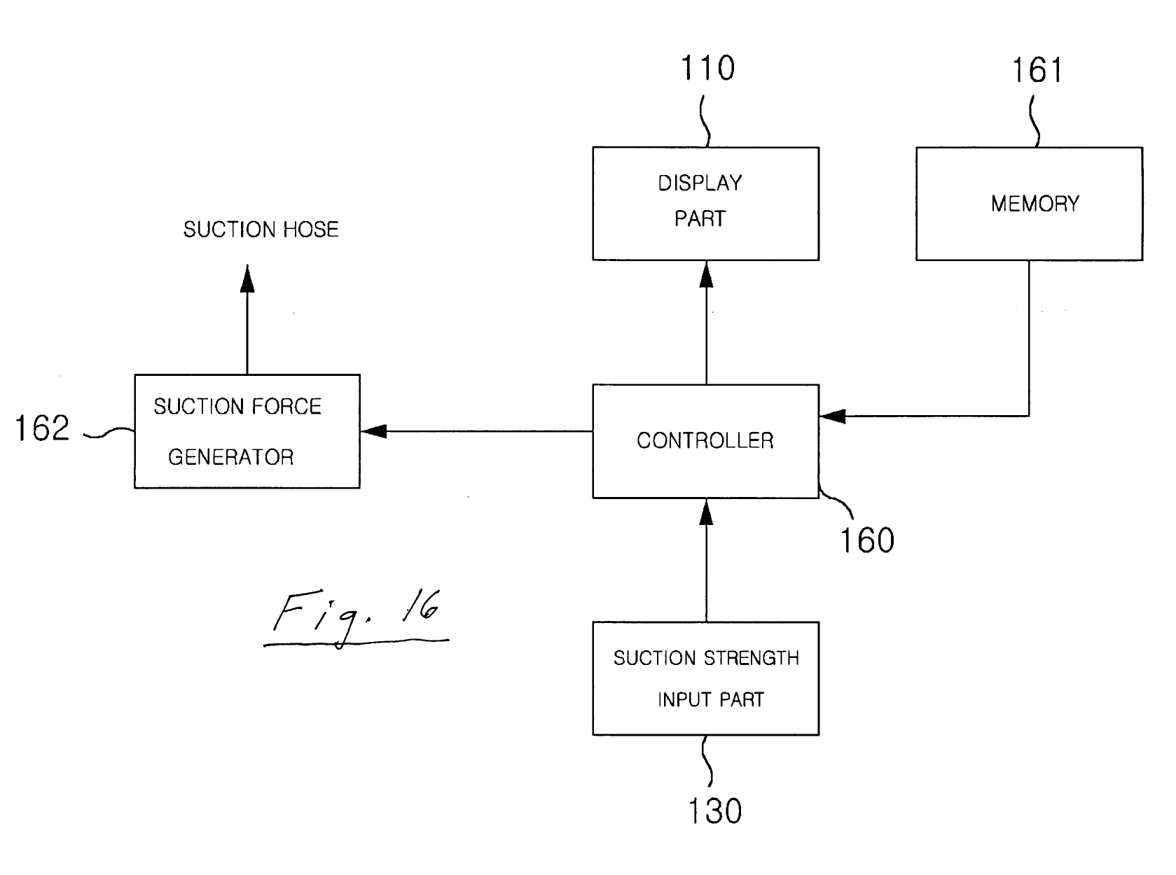

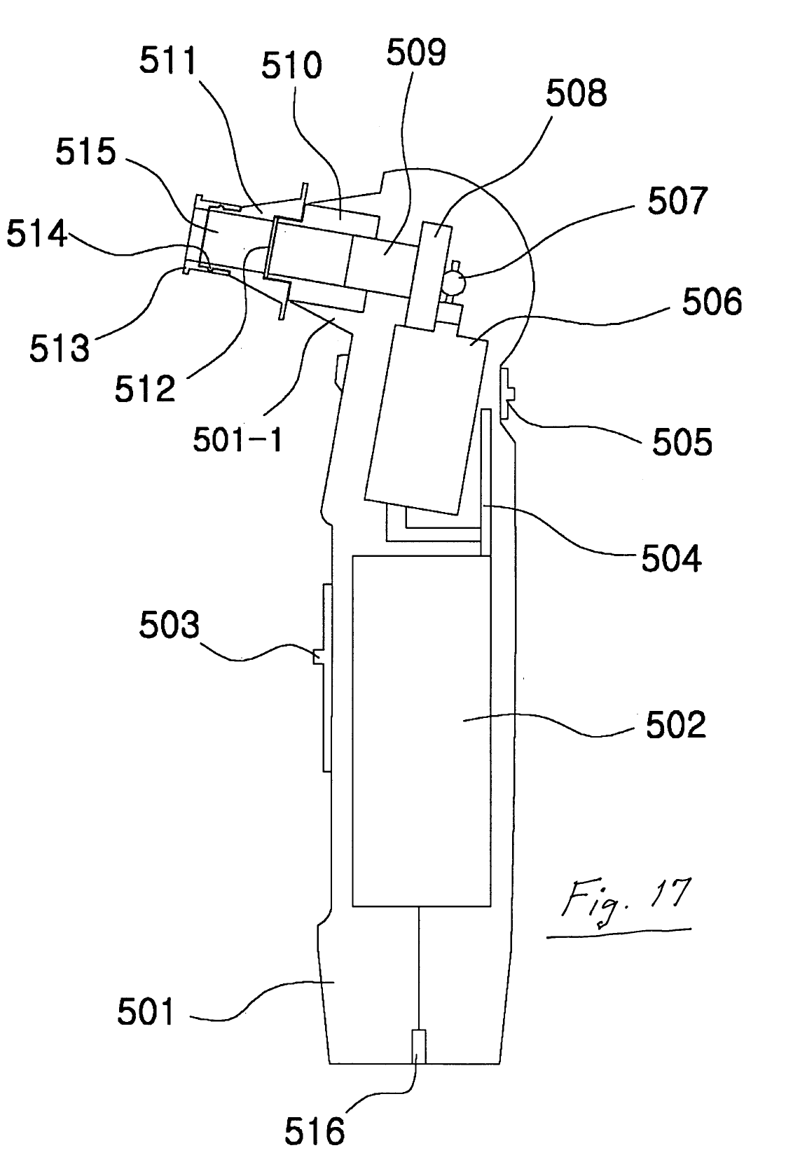

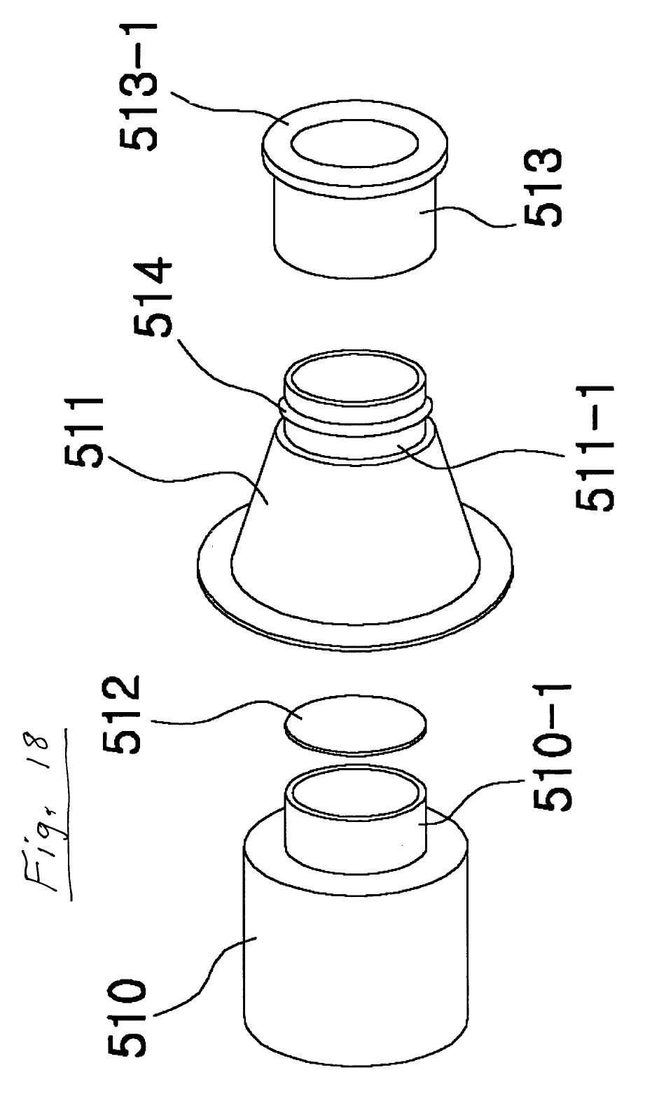

FIG. 1 is a view illustrating an outlook of a skincare apparatus according to the present invention, FIGS. 2 through 15 are views illustrating a hand piece and a tip adapted to remove a skin foreign substance according to various embodiments of the present invention, FIG. 16 is a view illustrating a circuit block provided in the interior of a body according to an embodiment of the present invention, and FIGS. 17 and 18 are views illustrating the construction of another embodiment of the present invention.

As shown in FIG. 1, a display part 110 is provided on an upper surface of a body 100 for displaying an operation and function selection state for a user. The display part 110 may be achieved with a liquid crystal display or a LED.

In addition, an accommodating part 104 adapted to accommodate a suction hose 200 and a hand piece 300 is provided. A tip storing part 102 is provided in one side of the accommodating part 104 for storing a tip 400.

In addition, a cover 101 is provided to cover an upper side of the body 100, and a mirror 103 is provided in an inner side of the cover 101.

A power switch 120 is provided in an upper side of the body 100 for switching on and off the power of the skincare apparatus. A suction hole 200 is connected for transferring a suction force from the body 100 to the hand piece 300. Various button parts, namely, a suction strength input part 130 is provided for adjusting the suction strength.

An adaptor jack 170 is provided in a side surface of the body 100 for supplying the power.

FIG. 2 is a view illustrating a hand piece and a tip according to an example of the present invention.

One end of the hand piece 301 through which a hollow part 302 passes is engaged with the suction hose 200, and a protrusion part 303 is provided in the other end of the same.

A filter engaging part 304 having a circular step is formed in an inner end of the protrusion part 303, and a disposable type free filter 306 is engaged thereon.

One or more O-ring is provided in an outer side of the protrusion part 303, and a tip 401 is engaged to the protrusion part 303.

A diamond powder is electrodeposited on the end 402 of the tip 401. Skin keratin, etc. are peeled when the end 402 contacts with the skin.

The diamond powder is electrodeposited on all tips (described later).

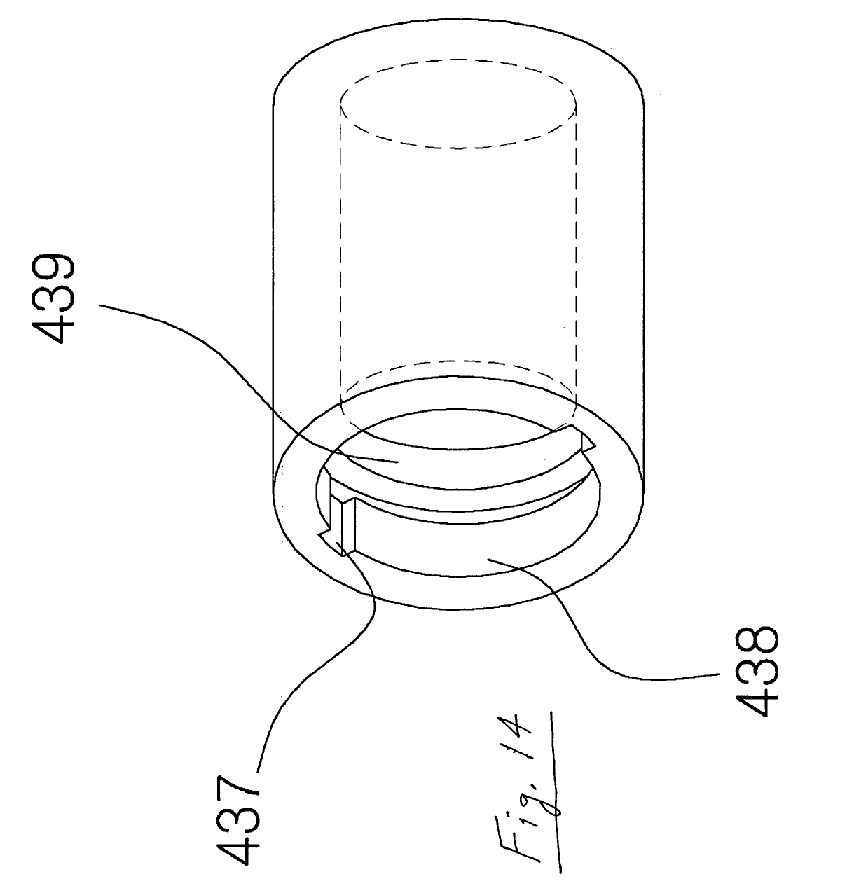

Therefore, when a user inputs a button of the suction strength input part 130, as shown in FIG. 14, a controller 160 controls the system to generate a suction force by controlling a driving operation of a suction generator 162 formed of a suction motor. The suction force is transferred to the hand piece 301 through the suction hose 200. The foreign substances such as skin keratin, etc. peeled by the tip 401 are sucked.

The sucked skin keratin, etc. are filtered by the filter 306 and are not sucked into the interior of the body 100. Only the tip 401 is separated from the hand piece 301, so that the filter 306 is removed.

In another embodiment of the present invention, a diamond powder may be electrodeposited on the end of the hand piece 301 without using a tip.

The controller 160 is designed to easily control the suction force from the suction force generator 162 based on a digital method.

In the conventional art, a user adjusts a suction strength using an analog dial method for controlling the suction strength. At this time, in the case that the suction strength is incorrectly controlled, the skin may be damaged by a huge suction force.

In the present invention, a data value concerning a proper suction strength is previously stored in a memory 161. The controller 160 reads a suction strength data value from the memory 161 and controls an operation of the suction force generator 162 in accordance with a suction strength (high (H), middle (M), and low (L)) inputted through the suction strength input part 130.

Therefore, the user can easily control a suction strength, so that a skin damage occurring due to a user's input mistake is prevented.

In addition, the information concerning the suction strength is visually expressed for a user through the display part 110.

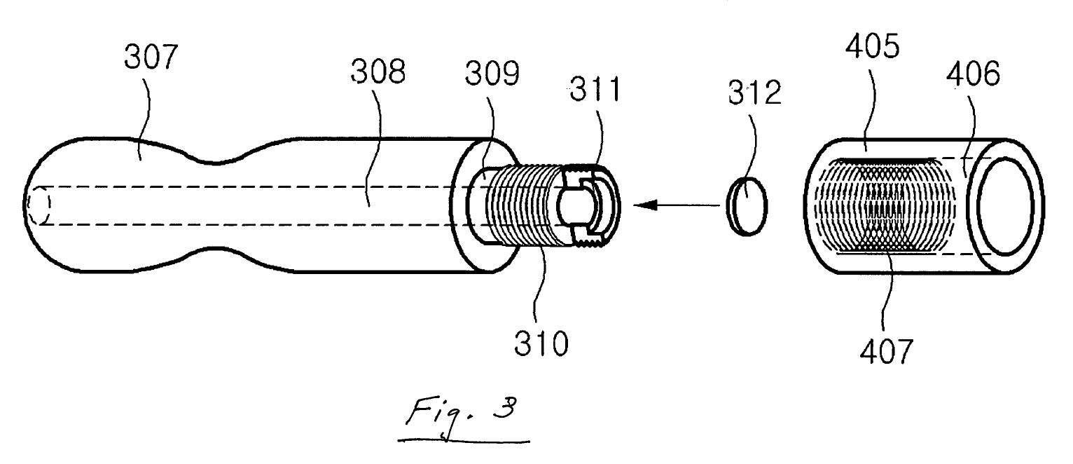

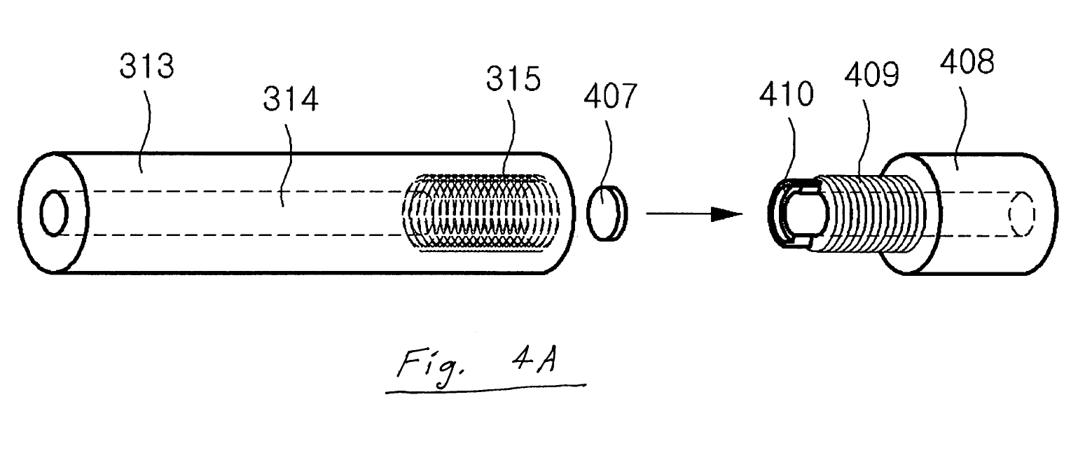

FIG. 3 is a view illustrating a hand piece and a tip of a second example of the present invention. As a different construction as compared to the first example of the present invention, a screw thread 310 is formed in the protrusion part 309 of the hand piece 307 for engaging the tip 405 instead of the 0ring. In addition, a screw thread 407 is formed in an inner surface of the hollow part 406 of the tip 405 and is engaged with the hand piece 307 and the tip 405.

At this time, the reference numeral 308 represents a hollow part, 311 represents a filter engaging part, and 312 represents a filter.

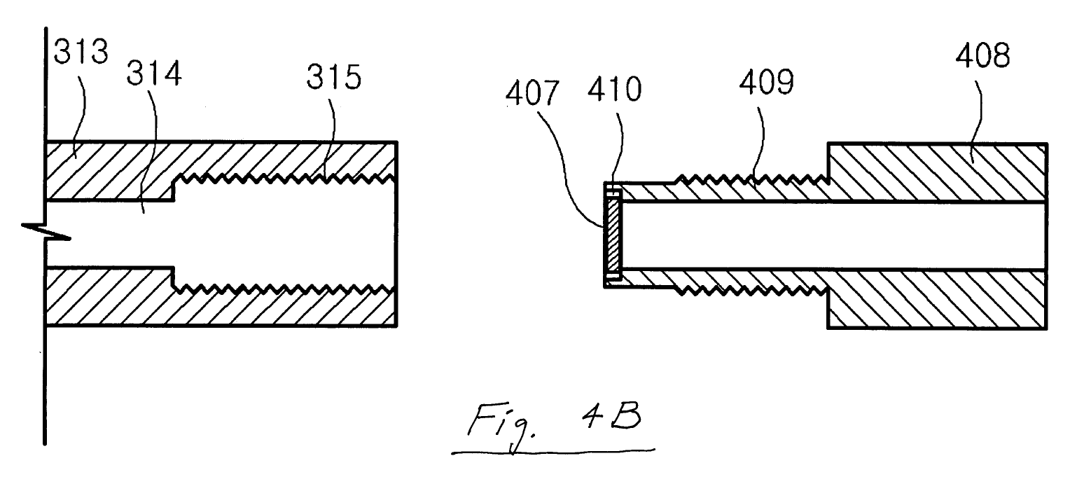

FIG. 4A is a view of a third example of the hand piece and a tip according to the present invention. A screw thread 315 is formed in an inner part of the hollow part 314 of the hand piece 313. A protrusion part 409 having a screw thread is formed in the tip 408. A filter engaging part 410 is formed in an inner side of the protrusion part 409.

Therefore, as shown in FIG. 4B, the filter 410 is engaged with the filter engaging part 410 and is screw threaded with the hand piece 313.

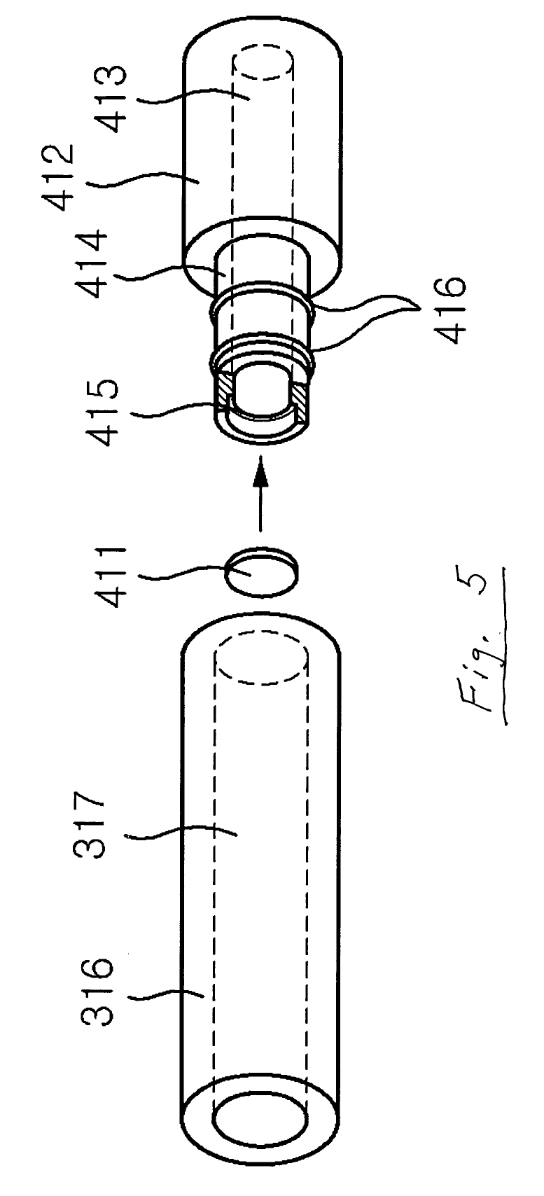

FIG. 5 is a view of a fourth example of the hand piece and the tip according to the present invention. Differently from the third example of the present invention, a plurality of O-rings 416 are provided in the protrusion part 414 of the tip 412 instead of the screw threads. The O-rings 416 are inserted into an inner hollow part 317 of the hand piece 316.

At this time, reference numeral 411 represents a filter, 413 represents a hollow part, and 415 represents a filter engaging part.

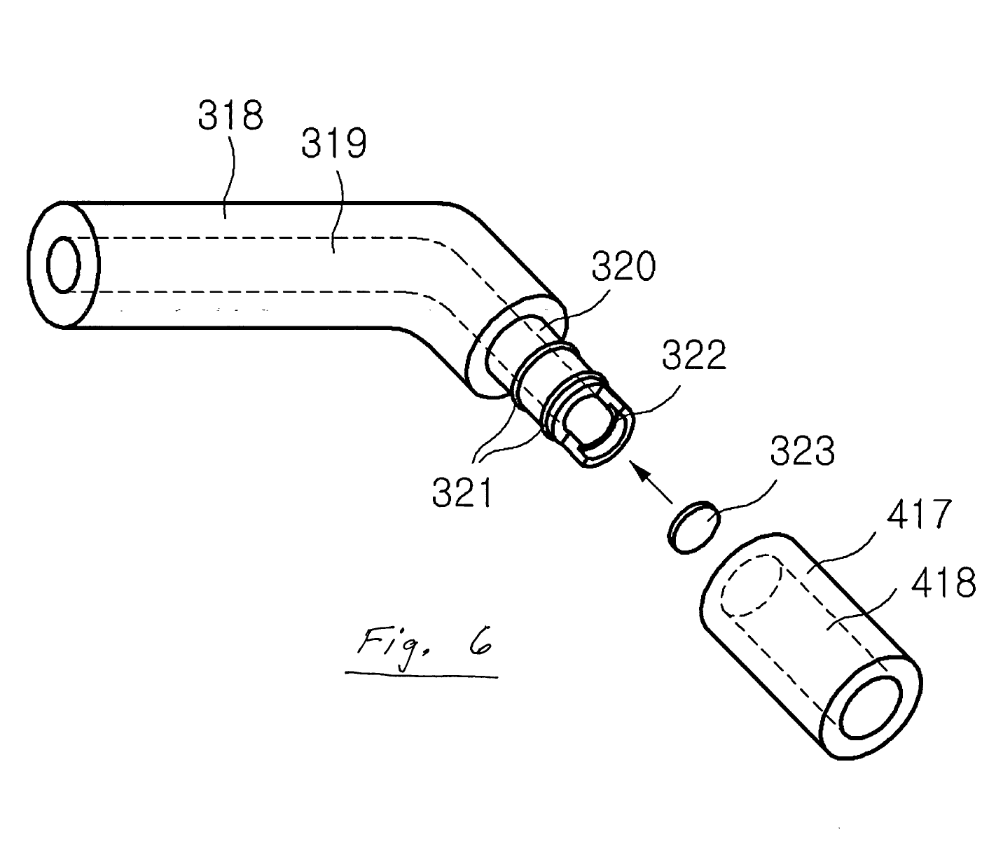

FIG. 6 is a view of a fifth example of the hand piece and tip according to the present invention. Differently from the first example of the present invention, a part of the body of the hand piece 318 is slanted at a certain angle (about 30˜80°), so that an end portion of the tip 417 closely contacts with the skin.

Namely, even when the user vertically holds the hand piece 318, an end portion of the tip 417 closely contacts with the skin.

Here, reference numerals 319 and 418 represent a hollow part, 320 represents a protrusion part, 321 represents an O-ring, 322 represents a filter engaging part, and 323 represents a filter.

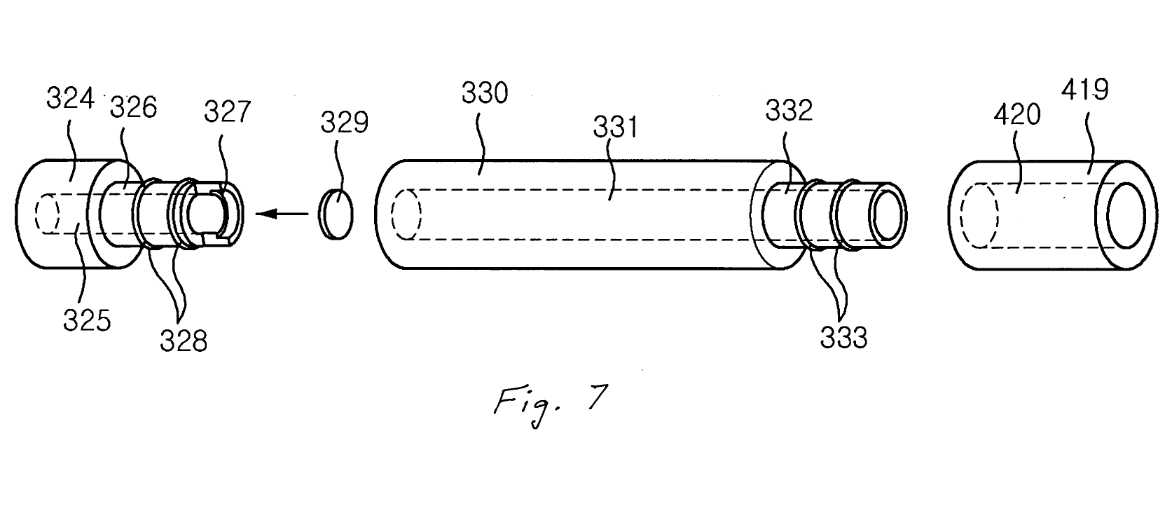

FIG. 7 is a view of a sixth embodiment of the hand piece and tip according to the present invention. Here, the hand piece is classified into a first piece 324 and a second piece 330.

A hollow part 325 passes through an inner side of the first piece 324, and a suction hose 200 is engaged with an end portion of the first piece 324, and a protrusion part 326 is provided at the other end of the same.

A filter engaging part 327 having a circular step is formed in an inner end portion of the protrusion part 326, and a filter 329 is engaged thereto.

One or more than one O-ring is provided in an outer side of the protrusion part 326, and one side of the second piece 330 is engaged with the protrusion part 303.

The hollow part 331 passes through the inner side of the second piece 330 like the first piece 324. The protrusion part 326 of the first piece 324 is engaged with one end of the same, and the other end of the same has the protrusion part 332.

At least one O-ring is provided in an outer side of the protrusion part 332. A tip 420 having a hollow part 419 is engaged with the protrusion part 332 of the same.

Therefore, only the hand piece is separated without separating the tip, so that the filter is exchanged. A screw thread may be formed in the protrusion 326, 332 instead of the O-ring for thereby achieving a screw thread engagement.

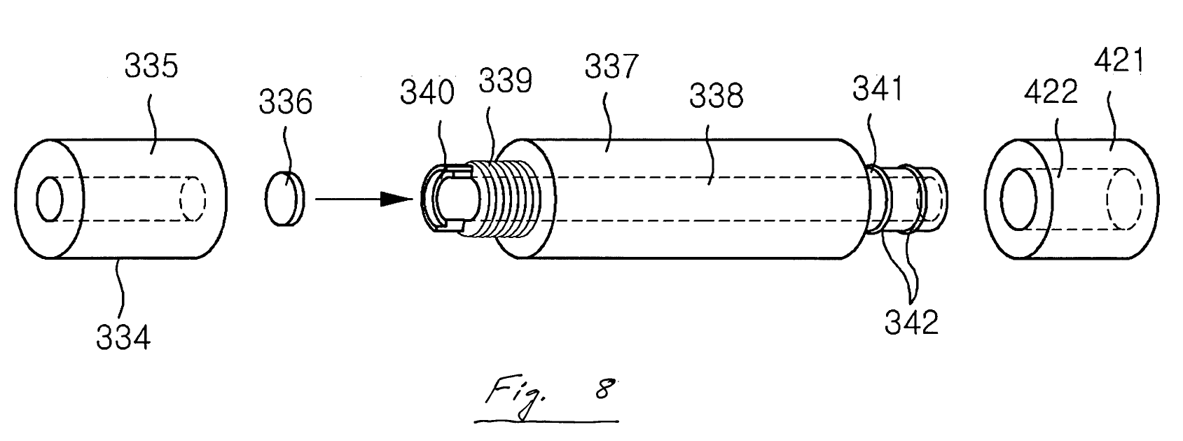

FIG. 8 is a view of a seventh example of the hand piece and the tip. The hand piece is classified into a first piece 334 and a second piece 337 like the sixth example of the present invention.

A hollow part 335 passes through the inner side of the first piece 334.

A hollow part 338 is formed in the inner side of the second piece 337. A

protrusion part is formed at both ends of the same. A protrusion part 339 having a screw thread is formed at one end of the same.

A filter engaging part 340 having a circular step is formed in an inner end portion of the protrusion 339, and a filter 336 is engaged thereto.

In addition, a protrusion part 341 having a plurality of O-rings 342 is provided at the other end of the second piece 337. A tip 421 is engaged with the protrusion part 341.

A screw thread instead of an O-ring or an O-ring instead of a screw thread may be formed in the protrusion part 339, 341.

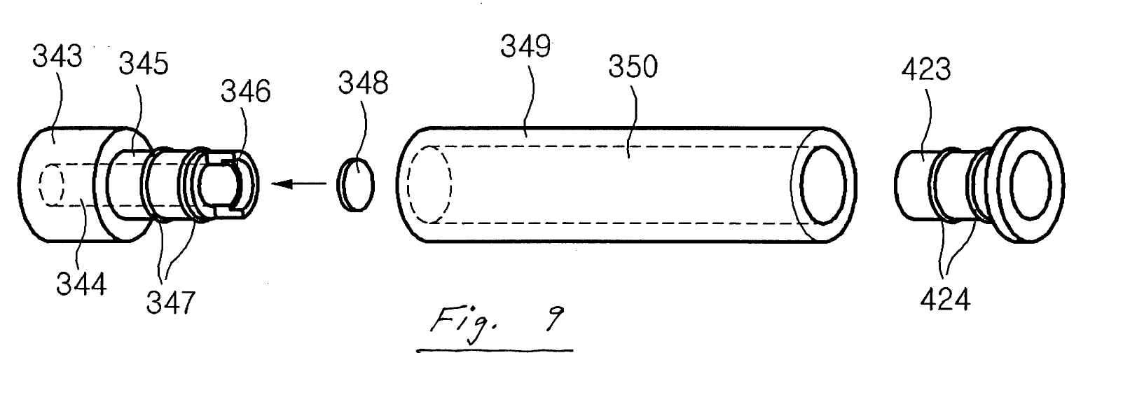

FIG. 9 is a view of an eighth example of the hand piece and the tip

according to the present invention. Here, the hand piece is formed of a first piece 343 and a second piece 349.

A hollow part 344 passes through an inner side of the first piece 343. The suction hose 200 is engaged with an end portion of the first piece 343. A protrusion 345 is provided at the other end of the same.

A filter engaging part 346 having a circular step is formed in an inner end side of the protrusion part 345, and a filter 348 is engaged thereto.

In addition, at least one O-ring is provided in an outer side of the protrusion part 345. One side of the second piece 350 is engaged with the protrusion 345.

A hollow portion 349 is formed in the interior of the second piece 350. The first piece 343 is engaged with one end of the same, and the tip 423 is engaged with the other end of the same.

A plurality of O-rings 424 are provided in an outer side of the tip 423 and are tightly engaged with the other end of the second piece 350.

A screw thread instead of the O-ring or an O-ring instead of the screw thread may be adapted for thereby achieving a stable engagement.

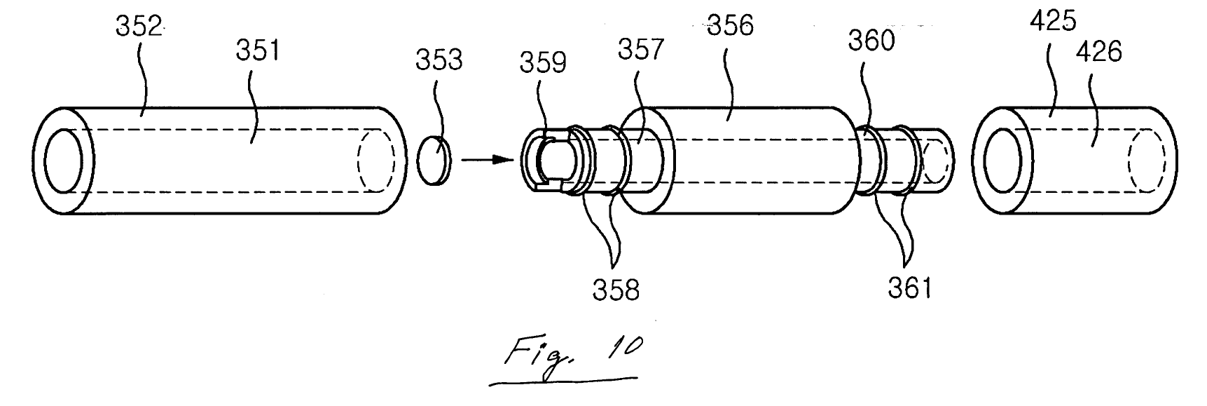

FIG. 10 is a view of a ninth example of the hand piece and tip according to the present invention. As described in the seventh example of the present invention, a plurality of O-rings 358 are provided in the protrusion part 357 instead of the screw threads. Therefore, the first piece 352 and the second piece 356 are inserted for thereby achieving an engaged construction.

In the drawings, reference numerals 352 and 426 represent a hollow part, 353 represents a filter, 359 represents a filter engaging part, 360 represents a protrusion part, and 361 represents an O-ring.

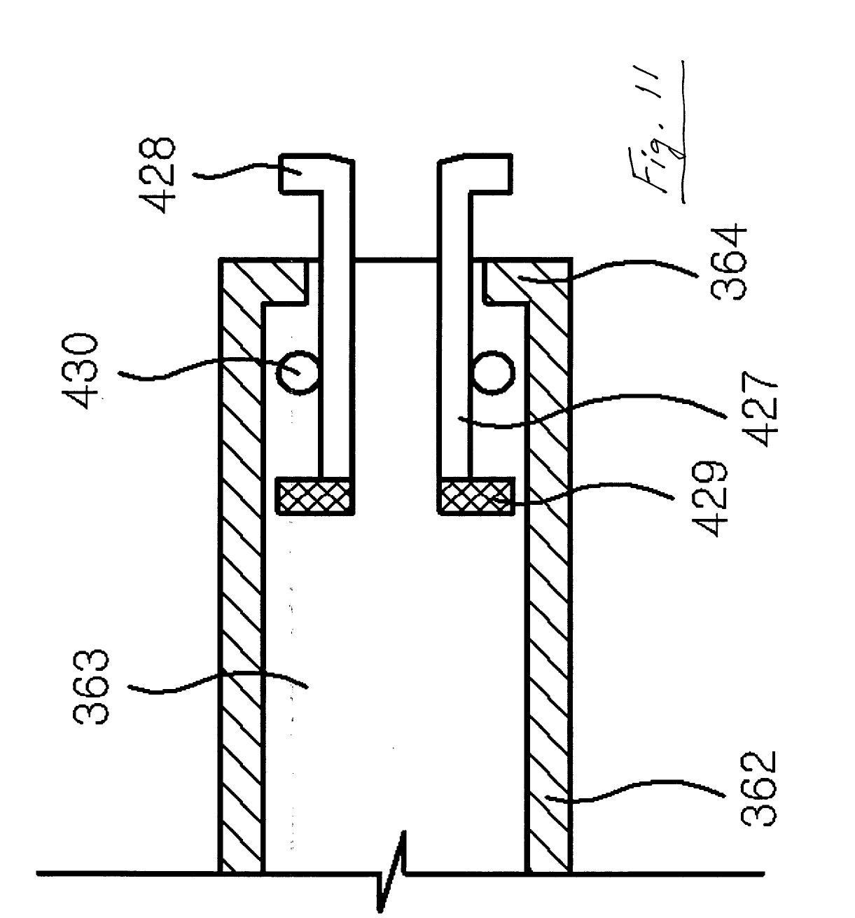

FIG. 11 is a view of a tenth example of the hand piece and tip according to the present invention. Here, the hand piece is formed in an integration body. Opened hollow parts 363 are provided at both side surfaces. An engaging step 364 inwardly bent is formed in an end portion of one side.

In addition, the tip 427 is also formed in an integration body. In the tip 427, engaging steps 428 and 429 are provided wherein both side surfaces of the same are opened, and the ends of both sides are outwardly bent. One side of the same is positioned in an inner side of the hand piece 362, so that it is prevented from being escaped to the outside of the hand piece by an engaging step 364.

At this time, the body of the tip 427 has a diameter smaller than the opened portion of the end portion of one side of the hand piece 362, so that a certain clearance is formed.

Namely, the diameter of the body of the tip 427 is smaller than the inner diameter of the engaging step 364, so that a certain clearance is formed. Therefore, the tip 427 becomes movable.

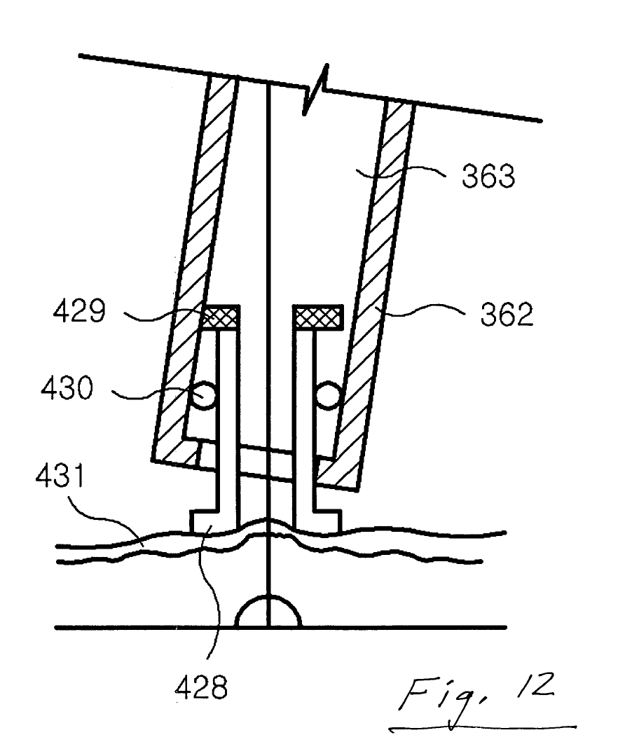

As shown in FIG. 12, when an end of the tip 427 contacts with the skin 431, even when the hand piece 362 is inclined, the tip 427 maintains a vertical state, namely, the end of the tip and the skin are maintained in a horizontal state.

In addition, an O-ring shaped elastic support part 430 is provided in an outer side of the body of the tip 427. Therefore, the elastic support part 430 closely contacts with the inner surface of the hollow part 363 of the hand piece 362. There is provided a recovering force by which the end of the tip 427 is maintained in a horizontal state.

Since the tip 427 electrodeposited by a diamond powder is uniformly contacted with the skin, the skin contacting with the tip 427 is uniformly peeled for thereby achieving a uniform peeling operation.

Namely, even when the user does not maintain the tip 427 in a horizontal state with respect to the skin, the ends of the tip 427 is always maintained in a horizontal state with respect to the skin, so that the skin is uniformly peeled without a biased peeling.

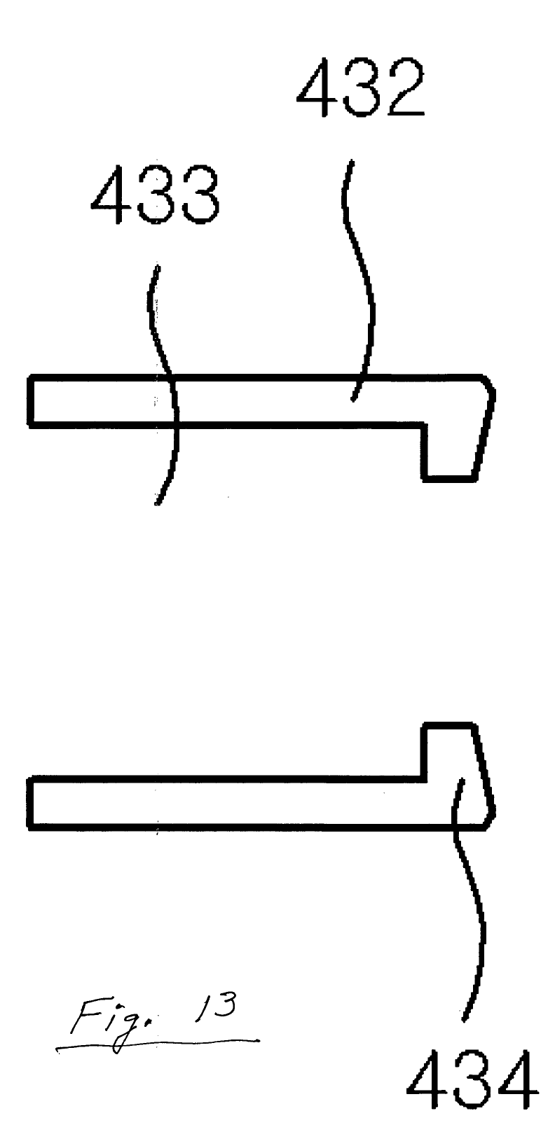

FIG. 13 is a view of an eleventh example of the tip according to the present invention. As shown therein, the end portion 434 of the tip 432 is tapered from the outer side to the inner side. Therefore, when the end portion 434 contacts with the skin, the biased peeling of the skin is decreased.

Namely, the skin is uniformly contacted with the tapered portions, so that the biased peeling of the skin is decreased.

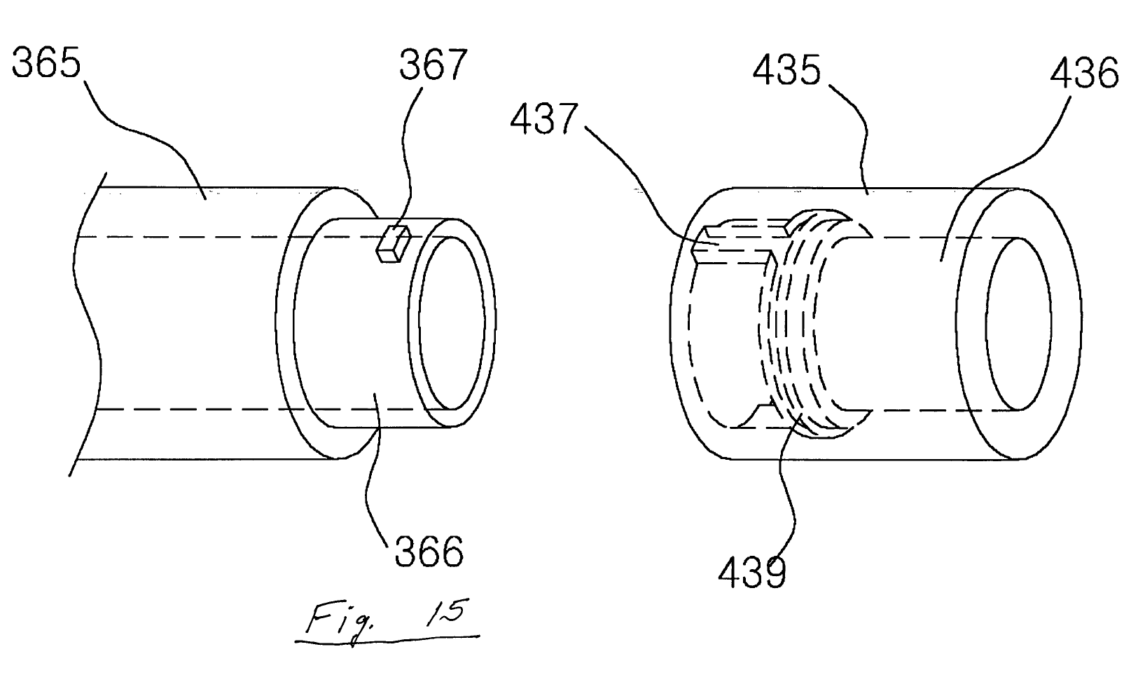

FIGS. 14 and 15 are views illustrating a hand piece and a tip according to a twelfth embodiment of the present invention. A protrusion 366 is provided at an end of the hand piece 165 for engaging a tip 435. At least one engaging protrusion 367 is provided at an outer portion of the protrusion part 368.

In addition, a hollow part 436 passes through the inner side of the tip 435. A circular engaging step 438 is formed in an inner end of the tip 435. A groove 437 is formed in the engaging step 438 wherein the engaging protrusion 367 of the hand piece 365 is inserted thereinto.

Therefore, when the protrusion 366 is inserted into the inner side of the tip 435, the engaging protrusion 367 is inserted into the groove 437, and the engaging protrusion 367 passes through the groove 437 and is positioned at the hollow part 436 of the inner side of the tip 435.

At this time, when the user rotates the tip 435 or the hand piece 365, the engaging protrusion 367 moves along the inner side of the engaging step 438 and is caught, so that the hand piece 365 and the tip 435 are engaged.

In addition, a stopper 439 is formed in a rear side of the engaging step 438 of the inner surface of the tip 435. Therefore, when the engaging protrusion 367 is inserted, it is stopped by the stopper 439, so that the insertion of the same is limited.

FIG. 17 is a view illustrating the construction according to another embodiment of the present invention. A charging battery 502 is provided in the interior of the hand piece, namely, in the interior of the body 501 for supplying the power. A motor 506 is provided in the upper side of the battery 502 for generating a vibration and suction force.

There is provided a PCB 504 having a control module for controlling the driving operation of the motor 506. A vacuum pressure generation tank 508 is provided for generating a vacuum suction force based on the driving operation of the motor 506.

A suction pipe 509 is connected with the vacuum pressure generation tank 508, and guides 510 and 511 and a tip 513 are engaged in the suction pipe 509.

An eccentric cam 507 is provided at the shaft of the motor 506, so that a vibration force is generated at the time when the motor 506 is operated. A power switch 503 is provided at an outer side of the body 503. There is further provided a button 506 for controlling the intensity of a vacuum pressure.

As shown in FIG. 18, the tip guides 510 and 511 and the tip 513 are inserted into a guide engaging port 501-1 of the body 501 for thereby forming a first guide communicating with the suction pipe 509. A protrusion part 510-1 is formed at an end of the first guide 510.

A filter 512 is provided at an end of the protrusion 510-1, and one side of the second guide 511 is inserted into an outer side of the protrusion 510-1.

A protrusion 511-1 is provided at the other side of the second guide 511. An O-ring 514 is inserted into the outer side, and then the tip 513 is inserted. A diamond powder is electrodeposited on the end of the tip 513 for thereby peeling skin.

The operation of the present invention will be described with reference to the accompanying drawings.

In a state that a user holds the body 501, when the user turns on the switch 503, the motor 506 is driven by the power charged in the battery 502.

A vacuum pressure is formed in the vacuum pressure generation tank 508 based on the driving of the motor 506, so that the suction pipe 509 has a certain suction force. Therefore, the vibrations are generated in the body 501 by the eccentric cam 507 connected with the shaft of the motor 506.

Therefore, the skin foreign substances are sucked through the first and second guides 510 and 511 communicating with the suction pipe 509 and the suction port 515 formed by the tip 514, and the sucked skin foreign substances are filtered by the filter 512.

There is provided a vacuum pressure intensity control button 506 in the body 501 for controlling the intensity of the vacuum pressure. When the user controls the intensity of the same, the control module provided in the PCB 504n limits the driving force of the motor 506, so that the suction force is controlled.

A jack connection port 516 is provided in the lower side of the body 501, so that the battery 502 is charged by the power externally applied.

As described above, in the skincare apparatus according to the present invention, the filter is engaged to the hand piece in such a manner that the filter is easily disengaged from the hand piece for thereby achieving an easier cleaning operation and use of the same.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A skincare apparatus that includes a body for generating a suction force, a suction hose of which one end is engaged with the body, and the other end is engaged with a hand piece, a hand piece adapted to receive a suction force from the suction hose and having a body held by a user's hand, and a tip engaged with the hand piece and directly contacting with skin, comprising:
an engaging means provided in the hand piece wherein a tip is engaged with one end of the same; and
a filter provided at a portion engaged by the engaging means for thereby filtering a skin foreign substance removed from skin based on a suction force.

2. The apparatus of claim 1, wherein said engaging means has a protrusion part protruded from an end portion of the hand piece and engaged with the tip, wherein a filter is engaged in an inner side of the protrusion part.

3. The apparatus of claim 2, wherein an O-ring or screw thread is formed in an outer side of the protrusion part.

4. A skincare apparatus that includes a body for generating a suction force, a suction hose of which one end is engaged with the body, and the other end is engaged with a hand piece, and a hand piece adapted to receive a suction force from the suction hose and having a body held by a user's hand, wherein an end portion of the same contacts with skin, comprising:
a hand piece of which an end portion of the same is electrodeposited by a diamond powder.

5. A skincare apparatus that includes a body for generating a suction force, a suction hose of which one end is engaged with the body, and the other end is engaged with a hand piece, a hand piece adapted to receive a suction force from the suction hose and having a body held by a user's hand, and a tip engaged with the hand piece and contacting with skin, comprising:
a hand piece having two or more than two pieces are detachably engaged by an engaging means for thereby forming one body, wherein a filter is provided at a portion of the engagement for thereby filtering a skin foreign substance removed from skin based on a suction force.

6. The apparatus of claim 5, wherein said engaging means has a protrusion part protruded from an end portion of one hand piece and engaged with another hand piece, wherein a filter is inserted in an inner side of the protrusion part.

7. The apparatus of claim 6, wherein an O-ring or a screw thread is formed in an outer side of the protrusion part.

8. A skincare apparatus that includes a body for generating a suction force, a suction hose of which one end is engaged with the body, and the other end is engaged with a hand piece, a hand piece adapted to receive a suction force from the suction hose and held by a user's hand, and a tip engaged with the hand piece and contacting with skin, comprising:
a tip formed in an integration body wherein both sides of the same are opened, and a diamond powder is electrodeposited on an end portion of one surface contacting with skin.

9. A skincare apparatus that includes a body for generating a suction force, a suction hose of which one end is engaged with the body, and the other end is engaged with a hand piece, a hand piece adapted to receive a suction force from the suction hose and having a body held by a user's hand, and a tip engaged with the hand piece and contacting with skin, comprising:
a tip having an engaging means provided at one end of the tip for engaging with a hand piece; and
a filter provided in a portion engaged by the engaging means for filtering a skin foreign substance removed from skin based on a suction force.

10. The apparatus of claim 9, wherein said engaging means includes a protrusion part protruded from an end portion of the hand piece wherein a tip is engaged with the same, wherein a filter is inserted in an inner side of the protrusion part.

11. The apparatus of claim 10, wherein an O-ring or a screw thread is formed on an outer side of the protrusion part.

12. A skincare apparatus that includes a body for generating a suction force, a suction hose of which one end is engaged with the body, and the other is engaged with a hand piece, a hand piece adapted to receive a suction force from the suction hose and held by a user's hand, and a tip engaged with the hand piece and contacting with skin, comprising:
a hand piece formed in an integration body, wherein both sides of the same are opened, and an inwardly bent engaging step is formed in one end of one side of the same; and
a tip formed in an integration body, wherein both sides are opened, and an outwardly bent engaging step is formed at both side ends, and one side of the same is positioned in an inner side of the hand piece, so that it is prevented from being escaped from the outside of the hand piece by the engaging step,
wherein the body of said tip has a certain clearance formed in such a manner that a width of the same is smaller than the opened portions of the end portions of the hand piece.

13. The apparatus of claim 12, wherein an elastic support member is provided between the body of the tip and the inner side of the hand piece, so that the tip and the hand piece are arranged on the same straight line.

14. A skincare apparatus that includes a body for generating a suction force, a suction hose of which one end is engaged with the body, and the other end is engaged with a hand piece, a hand piece adapted to receive a suction force from the suction hose and having a body held by a user's hand, and a tip engaged with the hand piece and contacting with skin, comprising:
a body including:
a suction motor for generating a suction force;
an input part for applying an input signal for selecting a suction is force of the suction motor;
a memory for storing a plurality of different suction force generation values for driving the suction motor; and
a controller for selecting a suction force generation value stored in the memory in accordance with an input signal of the input part and controlling a suction force of the suction motor.

15. The apparatus of claim 14, further comprising a display unit for visually displaying an intensity of a suction force generated by the suction motor.

16. A skincare apparatus, comprising:
a power supply unit provided in the interior of a body of a hand piece;
a motor driven by a power supplied from the power supply unit;
a vacuum pressure generator tank for generating a suction force by the driving of the motor;
a guide protruded toward an outer portion of the body for thereby transferring a suction force from the vacuum pressure generation tank; and
a tip engaged with an end portion of the guide and contacting with a skin wherein said tip is integrally formed in the body of the hand piece.

17. The apparatus of claim 16, wherein said guide is divided into first and second guides wherein said first and second guides are engaged by an engaging means, and a filter is provided at the engaged portion.
